(19) United States
(12) Patent Application Publication
(10) Pub. No.: US 2004/0192351 A1
(43) Pub. Date: Sep. 30, 2004

(54) Method and system for mobile display of context-based advertising content

(76) Inventor: Daniel N. Duncan, Austin, TX (US)

Correspondence Address: HAMILTON & TERRILE, LLP, P.O. BOX 203518, AUSTIN, TX, 78720, US

(21) Appl. No.: 10/404,227

(22) Filed: Mar. 31, 2003

(51) Int. Cl. H04B 1/06

(52) U.S. Cl. 455/456.3; 455/345; 455/456.5; 455/566

(57) ABSTRACT

Context-relevant proximity-driven mobile advertising is accomplished by displaying advertisement content at display devices associated with mobile vehicles based on the context of the vehicles, such as location and time. An advertising context module associates plural advertisement contents with selected contexts. An advertising display controller associated with each vehicle uses a location provided by a locator device, such as a GPS locator, to determine a vehicle context and applies the context to select advertisement content for display at the vehicle.

### BACKGROUND OF THE INVENTION

1. Field of the Invention

The present invention relates in general to the field of displaying advertising content, and more particularly to a method and system for mobile display of context-based advertising content.

2. Description of the Related Art

Advertisers typically strive to display advertising to relevant audiences by targeting specific advertising content to specific contexts. One example of a targeted context is audience gender. For instance, advertisers often prefer to show commercials for goods or services of interest to women during television shows more commonly watched by women. Other examples of targeted contexts include audience age, income, location and education. In order to target advertising content to a desired context, advertisers often perform extensive and expensive research. By targeting advertising content to desired contexts, advertisers spend media dollars more effectively since the advertising content is more likely to be exposed to individuals to whom the advertising content is relevant.

One difficulty with presenting advertising content in a desired context is that context generally changes for a given time and location. For instance, a restaurant might post a billboard advertisement along a busy road to inform drivers on the road of the proximity of the restaurant and a lunch meal of interest. During lunch meal times, the billboard will generally have its greatest impact since the advertising content is most relevant at lunch time. At dinner meal time, the billboard will have some relevance to drivers in that it will inform drivers of the proximity of the restaurant, however the relevance of the lunch meal content will be reduced. During non-meal times or when the restaurant is closed, the billboard has the least relevance. However, the restaurant generally must leave the billboard advertisement up throughout the day and pay a full time fee to the billboard owner even though the greatest relevance and value to the advertising restaurant occurs over a relatively small period of time. Similarly, advertisements presented on mobile vehicles, such as trucks or taxis, are generally stuck with one display even in areas where the display becomes irrelevant due to movement of the vehicle to areas having different contexts.

### SUMMARY OF THE INVENTION

Therefore a need has arisen for a method and system which display advertising content using context-relevant proximity.

In accordance with the present invention, a method and system are provided which substantially reduce the disadvantages and problems associated with previous methods and systems for displaying advertising content. Advertising content is displayed on one or more mobile vehicles based on the context of the vehicle, such as the location of the vehicle, time of display and motion of the vehicle.

More specifically, one or more advertising content modules have plural advertisement contents configured for display through a display device. One or more advertising context modules associates each advertisement content with a context, such as a location or time. An advertisement display controller associated with each of plural vehicles determines the vehicle location from a locator device and selects an advertisement content for display based on the context associated with the advertisement content and the vehicle position. Context varies with proximity to selected locations and with the movement of the vehicle. In one embodiment, context varies with proximity of two or more of the plural vehicles to each other so that advertisement content displayed on the vehicles is coordinated by a synchronization and differentiation engine.

The present invention provides a number of important technical advantages. One example of an important technical advantage is that context-relevant proximity-driven mobile advertising more effectively targets advertisement content to selected audiences. Mobile video billboards coordinate advertisement content based on location and time context to display content having greater relevance as vehicles move from location to location over a time period. Further, coordinated displays by proximately located vehicles allow synchronization or differentiation of content for greater effectiveness to a selected context.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for mobile display of context based advertising content.

### DETAILED DESCRIPTION

The present invention provides context-relevant, proximity-driven mobile presentation of advertising content by tracking the positions of vehicles configured to display advertising content and selecting content for display based upon the context of the vehicle. For instance, content is displayed based on the audience likely to be exposed for a given vehicle position and time of day, based on the movement or lack of movement of the vehicle or based on the advertising content presented on other vehicles within a predetermined proximity to the given vehicle. Advertisers are thus provided with a powerful and versatile tool that presents advertising content in a coordinated manner to more effectively communicate an advertising message to a targeted venue or audience.

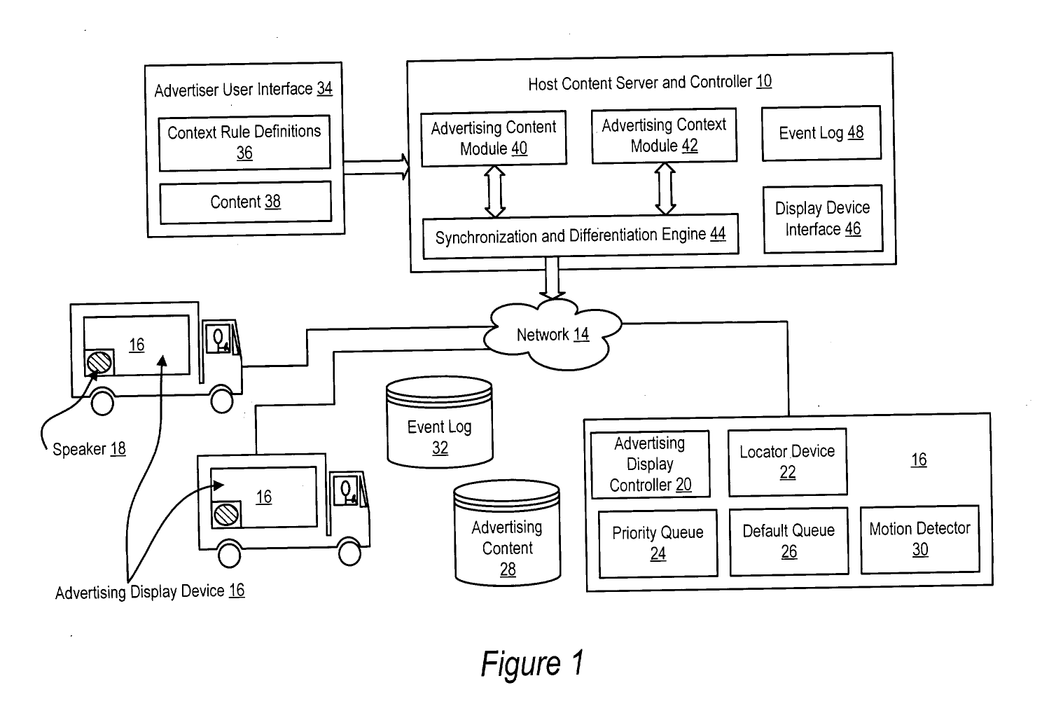

Referring now to FIG. 1, a block diagram depicts a system for mobile display of context based advertising content. A host content server and controller coordinates display of advertising content on plural vehicles 12 through a wireless network 14 for public presentation on an advertising display device 16. Wireless network 14 communicates advertising content and presentation queues to vehicles and vehicle position from vehicles via WiFi (e.g. 802.11g), GSM/GPRS wireless networks or other wireless technique. Advertising display devices 16 present visual advertising content through display devices, such as plasma, LCD or nanodisplay screens, and present audio advertising content through speakers 18. Vehicles 12 are dedicated or commercial vehicles, such as delivery vehicles, long or short haul trucks, taxi cabs, city buses, subway cars or commuter trains, that carry advertising display devices 16 as video billboards visible to the public. Advertising display devices 16 are secured against theft and encased in antiglare glass to improve visibility to viewers, with a given vehicle having one or more display devices 16 arranged in various positions.

Each advertising display device 16 includes an advertising display controller that communicates with host content server and controller 10 and controls the advertising content displayed at the vehicle. Advertising display controller 20 determines the vehicle position from a locator device 22 and applies the position and time to either a priority queue 24 or default queue 26 to select advertising content from an advertising content database 28 for display at the vehicle. A motion detector 30 determines whether vehicle 12 is moving or stationary to allow advertising display controller 20 to set a rate of change for the displayed content. An event log 32 tracks the display of content at vehicle 12 for tracking of displayed content and context which is periodically uploaded to host content server and controller 10. In one alternative embodiment, advertising content 28, priority queue 24 and default queue 26 are initially set through a hardwired interface, such as an Ethernet interface, and then updated through wireless network 14 when vehicle 12 is in motion.

Host content server and controller 10 establishes a relationship between advertising content and display device context, such as location, time, movement and proximity to other display devices, and generates a priority queue 24 and default queue 26 for each advertising display device 16. For instance, an advertiser user interface 34 accepts context rule definitions 36 and advertising content 38 from advertisers. An advertising content module 40 accepts advertising content, such as multimedia display information that includes video and audio information. Advertising context module 42 accepts and applies context rule definitions to associate display times and locations with the advertising context. A synchronization and differentiation engine 44 associates selected contexts with selected content to generate queues of content for display and communicates the queues through a display device interface 46. A priority queue 24 is generated to associate vehicle position with priority advertising based on the proximity of the vehicle to a targeted venue so that advertising display controller 20 is triggered to display priority content when locator device 22 places the vehicle within a predetermined distance of a context location. A default queue 26 is generated to identify a default list of advertising content when the position of the vehicle does not result in the use of a priority queue. An event log 48 tracks advertising display events received from vehicles and is accessible by synchronization and differentiation engine 44 to alter priority queues for selected vehicle based on the content displayed by other vehicles positioned proximate to the selected vehicle. Event log 48 also monitors advertisement displays for billing purposes including controlling displays to avoid bills in excess of a predetermined amount input by an advertiser.

As an example, an advertiser inputs a set of advertising content and associated context rule definitions through advertiser user interface 34 to host content server and controller 10. Advertisement A content relates to a restaurant having a context of lunch time within a defined radius of the restaurant; advertisement B content relates to breakfast cereal with a preferred context of morning; and advertisement C content relates to a beverage without a time context. Advertising context module 42 generates a priority queue 24 for Advertisement A to be presented when a vehicle is within the defined radius and a default queue 26 for displaying the three advertisements at varied rates based on time of day and proximity to other vehicles when outside the defined radius. The advertising content, priority queue and default queue are uploaded to a fleet of delivery vehicles at the start of the business day through an Ethernet interface and the vehicles proceed on their routes tracked by locater devices 22 and updated periodically through wireless network 14. Displayed advertisements are tracked in event log 32 and periodically reported to host content server and controller 10 along with vehicle position.

When moving outside the predetermined radius of the restaurant, the vehicles display the advertising content according to the default queue at a given rate of change, such as changing the advertisement every five minutes. If motion detector 30 detects that a vehicle becomes stationary, the rate of change can increase or decrease such as to change advertisements every 30 seconds. If locator device 22 indicates that the vehicle is within the predefined radius to the restaurant, advertising display controller 20 depicts advertisements according to the priority queue. In one embodiment, the displayed content is altered based on vehicle position and direction, such as pointing an arrow in the direction of the restaurant, depicting “follow me” when heading towards the restaurant or depicting “turn around” when heading away from the restaurant. As vehicles change position resulting in changes to their proximity relative to each other, synchronization and differentiation engine 44 alters the priority and default queues to provide a coordinated advertising campaign. For instance, as two vehicles travel near each other, the content on the vehicles is synchronized to emphasize an advertising message or differentiated to display multiple contents by downloading a priority queue generated by synchronization and differentiation 44. As one example of a coordinated advertising presentation, the breakfast cereal advertisement B is displayed on one delivery vehicle while another nearby delivery vehicle displays content suggesting purchase of the beverage advertisement C for use with the breakfast cereal.

Although the present invention has been described in detail, it should be understood that various changes, substitutions and alterations can be made hereto without departing from the spirit and scope of the invention as defined by the appended claims.

What is claimed is:

1. A system for mobile display of advertising content, the system comprising:
one or more advertising content modules having plural advertisements configured for display through a medium;
one or more advertising context modules operable to associate an advertisement with a display location;
plural mobile vehicles distributed across plural locations;
an advertising display device associated with each vehicle;
a locator device associated with each vehicle, the locator device operable to determine the location of the vehicle; and
an advertising display controller associated with each vehicle and in communication with the locator device, with an advertising content module, and with an advertising context module, the advertising display controller operable to display an advertisement of the advertising content module on an advertising display device of the associated vehicle, the displayed advertisement selected based on the vehicle location determined by the location device and the advertisement associated with the determined location by the advertising context module.

2. The system of claim 1 wherein the advertising context module is further operable to associate an advertisement with a display time.

3. The system of claim 2 further comprising an advertising display log interfaced with the advertising display controllers and operable to track advertisements displayed on vehicles by vehicle location and time.

4. The system of claim 3 wherein the advertising context module is further operable to communicate with the advertising display log and to determine an advertisement for display at a time and location based on the log of displayed advertisements.

5. The system of claim 4 wherein the advertising context module is further operable to communicate advertising context to plural advertising display controllers through a wireless network.

6. The system of claim 1 wherein the advertising display device comprises a plasma screen.

7. The system of claim 1 wherein the advertising display device comprises a nanodisplay screen.

8. The system of claim 1 wherein the advertising display device comprises a LCD screen.

9. The system of claim 1 wherein the advertising display device comprises a speaker operable to output sounds associated with an advertisement.

10. The system of claim 1 further comprising a motion detector associated with each vehicle and in communication with the advertising display controller, the motion detector operable to determine if the vehicle is in motion, the advertisement for display selected based on the motion determination.

11. The system of claim 10 wherein the advertisement for display is further selected based on the direction of motion.

12. The system of claim 1 further comprising an advertiser user interface in communication with the advertising content module and the advertising context module, the advertiser user interface operable to accept from an advertiser advertising content and context for display on the vehicles.

13. The system of claim 12 wherein the advertiser user interface is further operable to define a billing scheme for the display of advertisements, the system further comprising an event log operable to control advertisement display according to the billing scheme.

14. A method for mobile display of advertising content, the method comprising:
determining the position of a vehicle;
selecting a first advertisement for display at the vehicle based on the position determination;
displaying the selected first advertisement with a display device located on the vehicle;
determining the position of the vehicle as the vehicle moves;
selecting a second advertisement for display at the vehicle based on the position determination; and
displaying the selected second advertisement with the display device.

15. The method of claim 14 further comprising:
determining the time; and
selecting the advertisement based in part on the time.

16. The method of claim 14 further comprising:
determining whether or not the vehicle is in motion;
selecting the advertisement based in part on advertisement duration and the vehicle motion determination.

17. The method of claim 14 wherein the display device comprises a plasma screen.

18. The method of claim 14 wherein the display device comprises a nanodisplay screen.

19. The method of claim 14 wherein the display device comprises a LCD screen.

20. The method of claim 14 further comprising:
determining if the vehicle is in motion; and
selecting one or more advertisements for display based on the motion determination.

21. A method for mobile display of advertisements at plural vehicles, the method comprising:
communicating advertising content to each of the plural vehicles, the advertising content having plural displayable advertisements;
determining an advertising context for the advertising content, the advertising context associating one or more locations with each displayable advertisement;
determining the location of each of the plural vehicles; and
selecting an advertisement for display at each vehicle based on the vehicle location and advertising context.

22. The method of claim 21 further comprising displaying the selected advertisements at a plasma screen display associated with each vehicle.

23. The method of claim 21 further comprising displaying the selected advertisements at a nanodisplay associated with each vehicle.

24. The method of claim 21 further comprising displaying the selected advertisements at a LCD display associated with each vehicle.

25. The method of claim 21 further comprising outputting sounds associated with the selected advertisements through speakers associated with each vehicle.

26. The method of claim 21 further comprising:
determining whether the vehicle is moving or idle; and
selecting a first rate of change for displayed advertisements if the vehicle is moving and selecting a second rate of change for displayed advertisements if the vehicle is idle.

27. The method of claim 21 wherein determining the position of a vehicle further comprises determining the position of the vehicle with a GPS locator.

28. The method of claim 21 further comprising:
determining that two or more of the plural vehicles are within a predetermined proximity of each other; and
altering the selection of the advertisements for the two or more vehicles to display coordinated advertisements.

29. The method of claim 28 wherein the coordinated advertisements comprise synchronized advertising content for the two or more vehicles.

30. The method of claim 28 wherein the coordinated advertisements comprise differentiated advertising content for the two or more vehicles.
